(19) United States
(12) Patent Application Publication
(10) Pub. No.: US 2017/0055668 A1
(43) Pub. Date: Mar. 2, 2017

(54) NOVEL HEATER FOR HIGH-POWER HAIR DRYER

(71) Applicant: Guo Qiang CHEN, GUANGDONG (CN)

(72) Inventor: Guo Qiang CHEN, GUANGDONG (CN)

(21) Appl. No.: 15/054,158

(22) Filed: Feb. 26, 2016

(30) Foreign Application Priority Data
Aug. 28, 2015 (CN) 201510541550.9

(51) Int. Cl. A45D 20/12; H05B 3/46

(52) U.S. Cl. CPC A45D 20/12; H05B 3/46; H05B 2203/003; H05B 2203/022

(57) ABSTRACT

Disclosed is a novel heater for a high-power hair dryer, comprising a frame consisting of at least two interlaced plate-like heat-resistant insulators and an electric heating wire wound on the frame; the electric heating wire winds around the frame from the upper part to the lower part; the tail of the frame is provided with at least two silicon-controlled rectifiers, each connected to different parts of the electric heating wire via a connecting lead; besides, all silicon-controlled rectifiers are connected in turn. Through configuring the silicon-controlled rectifiers and connecting the silicon-controlled rectifiers to different parts of the electric heating wire, stepwise control over the heat of the hair dryer is achieved, meeting multiple hair-dressing demands and making independent control over the wind power of the hair dryer and the heating temperature possible.

### BACKGROUND OF THE INVENTION

The present invention relates to a heater of a hair dryer, specifically to a novel heater of a high-power hair dryer.

Heaters of current hair dryers usually control the heat of the wind through controlling the current. The entire electric heating wire generates heat at the same time, and the heat value increases and reduces along the rise and fall of the current. In such control mode, the motor and the heater of the hair dryer usually have a fan motor and the heating wire in a parallel circuit, binding the control over the heating temperature of the heating wire and the control over the motor power of the hair dryer together, so it places difficulties on complete independent control of the temperature of the heating wire and the wind volume of the electric hair dryer.

### BRIEF SUMMARY OF THE INVENTION

Aiming at the defects in the prior art, the present invention aims to provide a heater of a high-power hair dryer. Through configuring the silicon-controlled rectifiers and connecting the silicon-controlled rectifiers to different parts of the electric heating wire, stepwise control over the heat of the hair dryer is achieved, making independent control over the wind power of the hair dryer and the heat output possible.

To fulfill the above objective, the present invention employs the following technical solution:

A novel heater for a high-power hair dryer is provided, comprising a frame consisting of at least two interlaced plate-like heat-resistant insulators and an electric heating wire wound on the frame; the electric heating wire winds around the frame from the upper part to the lower part; the tail of the frame is provided with at least two silicon-controlled rectifiers, each connected to different parts of the electric heating wire via a connecting lead; besides, all silicon-controlled rectifiers are connected in turn.

It should be noted that, through configuring the silicon-controlled rectifiers and connecting the silicon-controlled rectifiers to different parts of the electric heating wire, the parts of the electric heating wire in connection with the corresponding silicon-controlled rectifiers can be controlled to generate heat by controlling the silicon-controlled rectifiers. Each silicon-controlled rectifier can only drive the corresponding part of the electric heating wire in connection to generate heat, so stepwise control over heating can be achieved through control over the quantity of the enabled silicon-controlled rectifiers, and the heat value of the part of the electric heating wire can be controlled through control over the volume of the current. Stepwise control over heating not only makes independent control over the heat value and wind volume in the hair dryer possible, but also reduces the voltage difference between parts of the electric heating wire in the heater of the hair dryer, avoiding contact of parts of the electric heating wire caused by collision, falling or impact when the hair dryer is in use, and damage of the heater because of burnout due to large voltage difference.

As an optimization, the electric heating wire is in U-shaped waveform. The electric heating wire winded in a U-shaped wave-form can effectively increase the heating area of the heater of the hair dryer.

As an optimization, the plate-like heat-resistant insulators are mica plates.

Furthermore, as an optimization, each of the plate-like heat-resistant insulators forming the frame has saw-tooth edges on two sides. The saw-tooth edges on two sides of the plate-like heat-resistant insulators can locate the electric heating wire such that the electric heating wire does not displace because the hair dryer collides or moves.

The present invention has the following beneficial effects:

1. Stepwise control over heating makes independent control over the heat value and wind volume of the hair dryer possible.

2. The winding method of the electric heating wire on the heater of the hair dryer is improved, thus increasing the heating area and enhancing the heat value.

3. Stepwise control reduces the voltage difference between parts of the electric heating wire in the heater of the hair dryer, avoiding contact of parts of the electric heating wire caused by collision, falling or impact when the hair dryer is in use and damage of the heater because of burnout due to large voltage difference.

### BRIEF DESCRIPTION OF THE DRAWINGS

FIG. 1 is a structural view of a side of the present invention.

FIG. 2 is a structural view of the bottom of the present invention.

### DETAILED DESCRIPTION OF THE INVENTION

The present invention is described in further detail with reference to the attached drawings. It should be noted that this embodiment provides detailed implementation means and specific operation process on the basis of this technical solution, but the protective scope of the present invention is not limited to the embodiment.

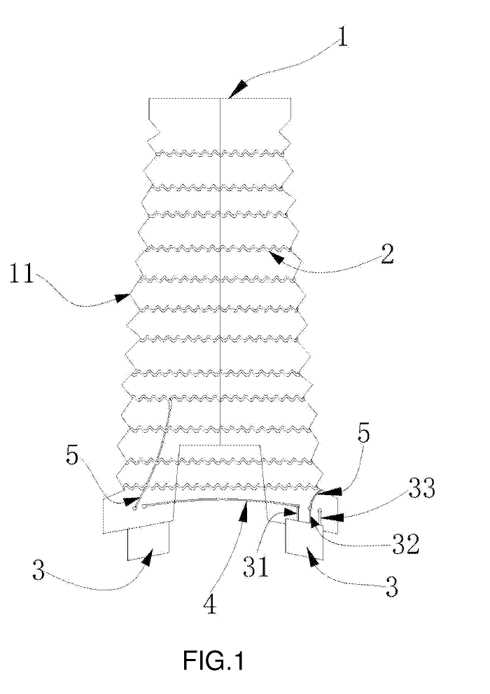

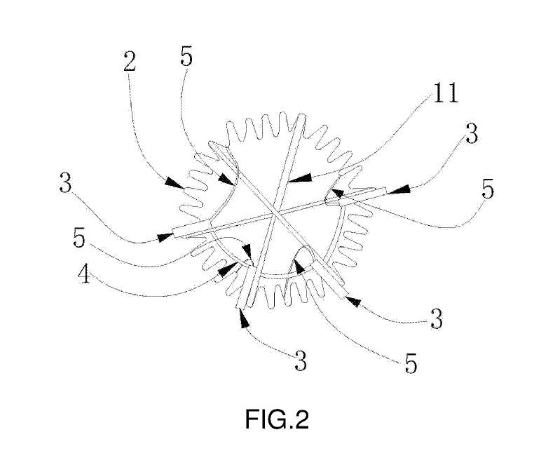

As shown in FIG. 1 and FIG. 2, a novel heater of a high-power hair dryer comprises a frame 1 consisting of three interlaced mica plates 11 and an electric heating wire 2 wound on the frame 1; the electric heating wire 2 winds around the frame 1 from the upper part to the lower part; the tail of the frame 1 is provided with four silicon-controlled rectifiers 3, each silicon-controlled rectifier 3 connected to different parts of the electric heating wire 2 via a connecting lead 5; besides, all silicon-controlled rectifiers are connected in turn through connecting wires 4.

Furthermore, as shown in FIG. 1, each silicon-controlled rectifier comprises a pin 31, a pin 32 and a pin 33; the pin 31 is connected to another silicon-controlled rectifier through the connecting wire 4; the pin 32 is connected to one part of the electric heating wire through the connecting lead 5; and the pin 33 is used for connecting the control circuit of the hair dryer.

It should be noted that through configuring the silicon-controlled rectifiers and connecting the silicon-controlled rectifiers to different parts of the electric heating wire, the parts of the electric heating wire in connection with the corresponding silicon-controlled rectifiers can be controlled to generate heat by controlling the silicon-controlled rectifiers. Each silicon-controlled rectifier can only drive the part of the electric heating wire in connection to generate heat, so stepwise control over heating can be achieved through control over the quantity of the enabled silicon-controlled rectifiers, and the heat value of the part of the electric heating wire can be controlled through control over the volume of the current. Stepwise control over heating not only makes complete independent control over the heat value and wind volume in the hair dryer possible, but also reduces the voltage difference between parts of the electric heating wire in the heater of the hair dryer, avoiding contact of parts of the electric heating wire caused by collision, falling or impact when the hair dryer is in use and damage of the heater because of burnout due to large voltage difference.

Furthermore, as shown in FIG. 2, the electric heating wire 2 is in U-shaped waveform. The electric heating wire winded in a U-shaped wave-form way can increase the heating area of the heater of the hair dryer and enhance the heat value.

Furthermore, the edges 111 on two sides of the mica plates 11 forming the frame 1 are saw-tooth like. The saw-tooth design of the edges on two sides of the mica plates can locate the electric heating wire such that the electric heating wire does not displace because the hair dryer collides or moves.

In use, the heater is installed at the front end of the hair dryer, the hair dryer is provided with a trigger switch with several shifts that is connected to the controller, so every silicon-controlled rectifier is independently connected to the controller, realizing control over the on-off of every silicon-controlled rectifier and the output current. When a certain silicon-controlled rectifier is switched on, the part of the electric heating wire in connection generates heat. Heating is stepwise controlled through controlling the quantity of the silicon-controlled rectifiers to be switched on. Besides, the heater can stepwise control heating, so the heater and the motor of the hair dryer can be independently controlled such that the heat value and wind volume of the hair dryer can be independently controlled, meeting more demands.

For those skilled in this field, various corresponding changes and modifications can be made according to the above technical solution and concept, and all those changes and modifications shall fall within the protective scope of the claims of the present invention.

What is claimed is:

1. A novel heater for a high-power hair dryer, comprising a frame consisting of at least two interlaced plate-like heat-resistant insulators and an electric heating wire wound on the frame, characterized in that, the electric heating wire winds around the frame from the upper part to the lower part; the tail of the frame is provided with at least two silicon-controlled rectifiers, each connected to different parts of the electric heating wire via a connecting lead; besides, all silicon-controlled rectifiers are connected in turn.

2. The novel heater for the high-power hair dryer according to claim 1, characterized in that the electric heating wire is a U-shaped waveform.

3. The novel heater for the high-power hair dryer according to claim 1, characterized in that, the plate-like heat-resistant insulators are mica plates.

4. The novel heater for the high-power hair dryer according to claim 1 or 3, characterized in that, each of the plate-like heat-resistant insulators forming the frame has saw-tooth edges on both sides.
